(19) United States
(12) Patent Application Publication
(10) Pub. No.: US 2010/0167198 A1
(43) Pub. Date: Jul. 1, 2010

(54) METHODS OF LIQUID TONER PRINTING

(75) Inventors: David W. Park, Puyallup, WA (US); Amar Neogi, Kenmore, WA (US); Michael J. Dougherty, Roy, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: NORTH PACIFIC PAPER CORPORATION (NORPAC), Longview, WA (US)

(21) Appl. No.: 12/347,735

(22) Filed: Dec. 31, 2008

(51) Int. Cl. G03G 13/10

(52) U.S. Cl. 430/119.6

(57) ABSTRACT

A method of printing using liquid toner generally includes obtaining a cellulose based substrate having a surface layer including nPCC, and printing on the cellulose based substrate using a liquid toner printer to achieve tape pull results of less than about 7%.

### CROSS-REFERENCES TO RELATED APPLICATIONS

Related patent applications include U.S. patent application Ser. No. 12/346,670 (WEYE 26547), filed Dec. 30, 2008, U.S. patent application Ser. No. 12/346,681 (WEYE Ref. 26548), filed Dec. 30, 2008, and U.S. patent application Ser. No. 12/346,690 (WEYE Ref. 26549), filed Dec. 30, 2008.

### BACKGROUND

Liquid toner printing presses, for example, printing presses manufactured by HP® under the trademark INDIGO®, have become popular for general commercial printing, as well as for label, flexible packaging, folding carton and specialty printing. The technology used is based on HP ELECTROINK®, a liquid toner that has small toner particles that can be attracted or repelled by means of a voltage differential.

The advantage of liquid toner printing presses over other printing presses is the ability to print without films and plates to enable personalized short runs that allow for changing text, images and jobs without having to stop the press. Liquid toner printing presses are particularly well-suited for consumer-generated web-to-print applications including, but not limited to, business cards, photo books, personalized, full-color direct mail and “transpromotional print” (e.g., combining invoices or statements with personalized promotional content).

Although generally known in the field of digital printing as “liquid” toner, the toner used for such printing is actually comprised of solid toner particles that are electrically charged and dispersed in a carrier liquid, for example, as described in U.S. Pat. No. 6,623,902, the disclosure of which is hereby expressly incorporated by reference. Due to the nature of the liquid toner, problems of transfer and adhesion of liquid toner images to substrates is well known. Therefore, a treatment of the substrate surface is generally required to enable good transfer and fixation, as described in U.S. Pat. No. 6,790,514, the disclosure of which is hereby expressly incorporated by reference.

In current practice, the cellulose based paper substrate used for printing in liquid toner printing presses generally includes a polyethylene imine (PEI) treatment to enhance toner adhesion. The PEI acts as a Lewis base or proton donor for the electrically charged toner particles. While PEI treatment allows for improved toner adhesion, it has the disadvantage of yellowing the paper substrate over time, which can be exacerbated by heat. PEI treated paper substrates, therefore, have a very limited shelf-life. Moreover, PEI is not compatible with other additives added during the papermaking process (such as optical brightener). As a result of this incompatibility, the PEI treatment is an inefficient off-line treatment process that occurs after the papermaking process.

In view of the yellowing problem, there exists a need for a method of printing using a liquid toner printing process using a suitable substrate that enables good toner adhesion and does not have the adverse affects of discoloration and brightness reduction. In addition, there exists a need for an efficient substrate treatment that can be applied directly at the paper size press during the papermaking process together with other size press components and additives.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a method of printing using liquid toner is provided. The method generally includes obtaining a cellulose based substrate having a surface layer including nPCC, and printing on the cellulose based substrate using a liquid toner printer to achieve tape pull results of less than about 7%.

In accordance with one embodiment of the present disclosure, a method of printing using liquid toner is provided. The method generally includes obtaining a cellulose based substrate having a surface layer, wherein the surface layer does not include PEI, and printing on the cellulose based substrate using a liquid toner printer to achieve tape pull results of less than about 7%.

In accordance with one embodiment of the present disclosure, a method of printing using liquid toner is provided. The method generally includes obtaining a cellulose based substrate having a surface layer, and printing on the cellulose based substrate using a liquid toner printer to achieve tape pull results of less than about 7%, wherein the cellulose based substrate has less than 10% brightness reduction after a period of about 2 months.

### DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 is a photographic image of a tape pull evaluation test for a 45# newsprint grade paper sample having a surface layer with 0 gsm nPCC;

FIG. 2 is a photographic image of a tape pull evaluation test for a 45# newsprint grade paper sample having a surface layer with 0.5 gsm nPCC;

FIG. 3 is a photographic image of a tape pull evaluation test for a 45# newsprint grade paper sample having a surface layer with 1.5 gsm nPCC;

FIG. 4 is a photographic image of a tape pull evaluation test for a 45# newsprint grade paper sample having a surface layer with 2.0 gsm nPCC;

FIG. 5 is a photographic image of a tape pull evaluation test for a 45# newsprint grade paper sample having a surface layer with 2.5 gsm nPCC;

FIG. 6 is a photographic image of a tape pull evaluation test for a 45# newsprint grade paper sample having a surface layer with 3.0 gsm nPCC; and

FIG. 7 is a photographic image of a tape pull evaluation test for an 80# glossy grade paper sample having a prior art PEI surface layer treatment.

### DETAILED DESCRIPTION

Embodiments of the present disclosure are generally directed to methods of printing on cellulose based substrates using a liquid toner printing process. In accordance with embodiments of the present disclosure, methods of printing include using cellulose based substrates that have surface layers. Such surface layers substantially reduce yellowing of the substrate over time for brightness retention, as compared to the prior art polyethylene imine (PEI) surface treatment. In addition, such surface layers enable good toner adhesion, as generally measured by the tape pull test described in greater detail below. In one embodiment, the method includes printing on a cellulose based substrate having a nano-precipitated calcium carbonate (nPCC) surface layer. While embodiments of the present disclosure may include methods of printing on cellulose based substrates having nPCC surface layers together with a PEI treatment, embodiments of the present disclosure are also directed to methods of printing on cellulose based substrates without PEI treatment.

To facilitate the understanding of the surface layers described herein, methods of making cellulose based substrates, cellulose based slurries, surface layers, resulting substrate characteristics, and nPCC morphology are described in greater detail below.

### Methods of Making Cellulose Based Substrates

In accordance with embodiments of the present disclosure, suitable cellulose based substrates include, but are not limited to, paper, fibreboard, containerboard, corrugated containerboard, Bristol board, board signage, paperboard, bleach board, newsprint, white top liner board, heavy basis weight white paper, tissue paper, napkins, and wall paper. In one embodiment, the cellulose based substrate is paper, such as a high yield paper. Exemplary paper making processes for making such high yield paper are described in U.S. patent application Ser. No. 12/346,670 (WEYE Ref. 26547), the disclosure of which is hereby expressly incorporated by reference.

### Cellulose Based Slurry

The components of an exemplary cellulose based slurries used in accordance with embodiments of the present disclosure may include wood fiber furnish and wet end chemicals. In exemplary embodiments, the cellulose based slurry may include mechanical pulp, kraft fiber, suitable fillers, and other wet end chemicals, such as internal sizing, opacifiers, brighteners, and dyes, and may achieve specific TMP freeness and TMP brightness values, for example, for high-yield paper, as described in U.S. patent application Ser. No. 12/346,670 (WEYE Ref. 26547), the disclosure of which is hereby expressly incorporated by reference.

### Surface Layers

Size press chemicals or materials may be placed on the cellulose based web at the size press to form a surface layer on the cellulose based substrate, for example, on the paper web. In accordance with embodiments of the present disclosure, the surface layer may include pigment, binder, and/or additional surface modifying chemicals may be added to the surface of the sheet at the size press. In one suitable embodiment, size press starch may be cooked and pumped to a tank where nPCC and other additives are added in. The surface layer materials that can be placed on the web at the size press must have a viscosity which allows for the transfer of the material onto the web. In addition, some of the surface layer materials may enter into the web if the pressure of the nip at the size press is high enough. Moreover, the surface layer materials can also be sprayed on the web prior to the dryer. The majority of surface layer materials that are sprayed on the web will remain on the surface of the web.

As mentioned above, a surface layer is provided to improve the desirable qualities of the cellulose based substrate, for example, to improve the toner adhesion to the substrate. As mentioned above, the surface layer includes nPCC. In one embodiment, the nPCC may be present in the surface layer in an amount in the range of about 1.25% to about 15% of the basis weight cellulose based substrate. In another embodiment, the nPCC may be present in the surface layer in an amount in the range of about 0.5 to about 10 gsm. In another embodiment, the nPCC may be present in the surface layer in an amount in the range of about I to about 6 gsm. In yet another embodiment, the nPCC may be present in the surface layer in an amount in the range of about 2 to about 5 gsm. “Nano” precipitated calcium carbonate refers to calcium carbonate having a mean particle size across the particle of less than about 200 nm. In one embodiment, nPCC having a mean particle size across the particle of less than about 200 nanometers is applied to the surface of a cellulose based substrate. In another embodiment, nPCC having a mean particle size across the particle of less than about 100 nanometers is applied to the surface of a cellulose based substrate. In another embodiment, nPCC having a mean particle size across the particle of about 15 nanometers to about 50 nanometers is applied to the surface of a cellulose based substrate. In another embodiment, the nPCC having a mean particle size across the particle of less than about 40 nanometers is applied to the surface of a cellulose based substrate.

In one embodiment of the present disclosure, the nPCC is preferably substantially non-agglomerated particles. For example, the nPCC may be formed using a high gravity reactive precipitation (HGRP) reactor to avoid particle agglomeration. A suitable nPCC is available from NanoMaterials Technology Pte Ltd (NMT).

Because an nPCC surface layer does have a significant charge to attract toner particles, the inventors unexpectedly found that a method including printing on a cellulose based substrate having an nPCC surface layer enables good toner adhesion. While not wishing to be bound by theory, the inventors believe that a surface layer including nPCC has good toner adhesion with liquid toner because of the self-binding attributes of the nPCC particles. In that regard, nPCC has an affinity to bind to itself and to the liquid toner particles, so as to mechanically “pack” on the paper with good binding efficiency. The inventors further believe that the nPCC may have a slight residual charge that tends to attract toner particles.

Toner adhesion is generally measured using a tape pull test after 15 and 60 minutes from the time of being printed. In accordance with the tape pull test, a section of printing blanket from an INDIGO 5000® printing press is placed on a hard surface with the rubber side up. A printed substrate to be tested is placed on the blanket with the solid color block test areas over the blanket. A piece of 1 inch SCOTCH®#230 drafting tape is placed over the test area. A second section of printing blanket is placed over the test areas with tape on them with the rubber side facing down, toward the tape. Each piece of tape is pressured into the sheet using a roller of a specific weight (1 kg) and dimension (13 cm wide), rolling first in one direction over the tape and then again in the opposite direction. The tape is then removed from each sample piece in a steady consistent motion. The samples are measured using image analysis for the amount of toner removed from each color block and reported as the percentage of toner remaining on the test area of the printed substrate.

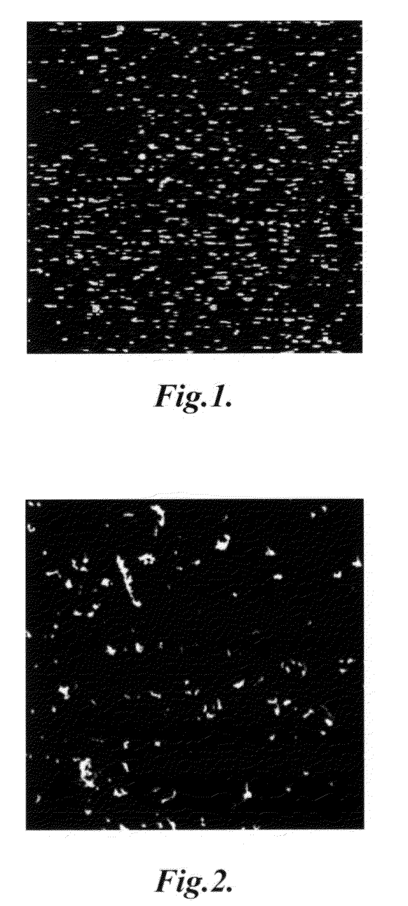

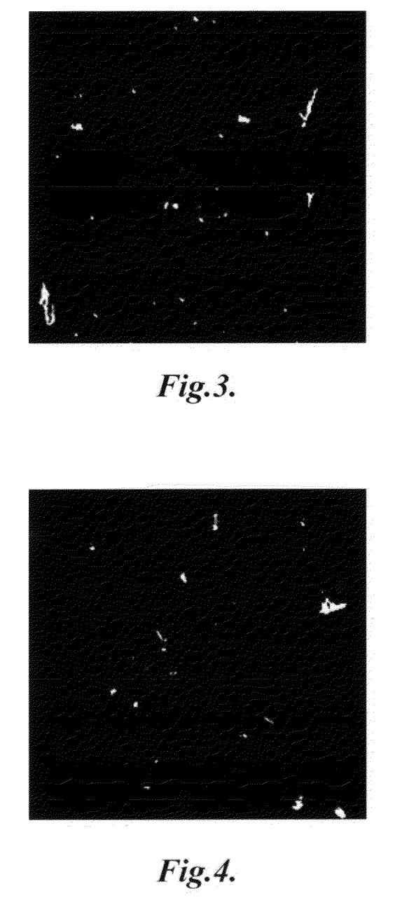

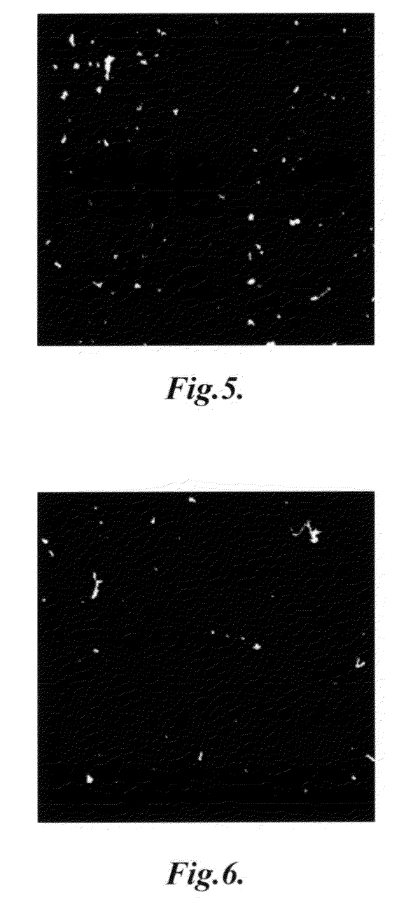

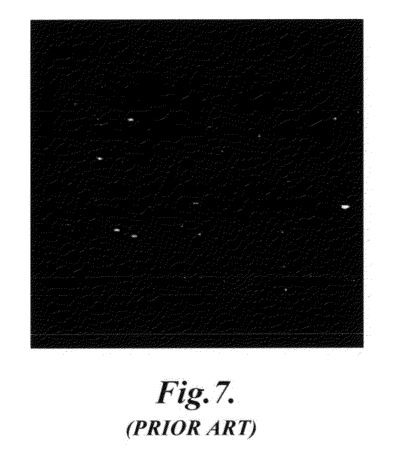

As shown below in the data in EXAMPLE 9 and TABLE 5, tape pull evaluation tests performed on five 45# newsprint grade paper samples having varying amounts of nPCC in the surface layer from 0.5 to 3.0 gsm nPCC achieved tape pull results of less than about 7%. Photographic images of the tape pull results are shown in FIGS. 2-6: 0.5 gsm nPCC (FIG. 2); 1.5 gsm nPCC (FIG. 3); 2.0 gsm nPCC (FIG. 4); 2.5 gsm nPCC (FIG. 5); and 3.0 gsm nPCC (FIG. 6). In comparison, a control sample of 45# newsprint grade paper sample having no nPCC in the surface layer achieved a tape pull result of 7.67% (see FIG. 1). Further in comparison, a normalized 45# newsprint grade paper sample having a PEI surface treatment will achieve a tape pull result of about 0.5% (see FIG. 7). A substrate having a tape pull result of less than about 2% is generally acceptable for liquid toner printing presses, for example, printing presses manufactured by HP® under the trademark INDIGO®.

In accordance with embodiments of the present disclosure, a substrate having an nPCC surface layer achieves tape pull test results of less than about 7%. In accordance with other embodiments of the present disclosure, a substrate having an nPCC surface layer achieves tape pull test results of less than about 5%. In accordance with other embodiments of the present disclosure, a substrate having an nPCC surface layer achieves tape pull test results of less than about 2%. In accordance with other embodiments of the present disclosure, a substrate having an nPCC surface layer achieves tape pull test results of less than about 1.5%. In accordance with other embodiments of the present disclosure, a substrate having an nPCC surface layer achieves tape pull test results of less than about 1%. In accordance with other embodiments of the present disclosure, a substrate having an nPCC surface layer achieves tape pull test results of less than about 0.5%.

In addition to good toner adhesion, the substrate having a surface layer including nPCC also has the added advantage of substantially reducing yellowing of the substrate over time for brightness retention, as compared to a prior art PEI surface treatment. Yellowing is generally measured by substrate brightness, according to TAPPI Brightness Method T452 om-02. Notably, a PEI surface treatment does not provide any added brightness value to a substrate as shown by comparing the control sample (Sample A) initial brightness value of 78 with the PEI only sample (Sample C) initial brightness value of 78 In EXAMPLE 10 and TABLE 6.

Moreover, optical brightener additives, such as OBA or FWA, tend to break down over time to reveal the actual brightness of the substrate underneath Therefore, the breakdown of optical brighteners further results in reduced brightness or yellowing of the substrate over time. Optical brighteners can be added at the wet end of the papermaking process, on the surface of the substrate at the size press, or both. Optical brighteners and nPCC also tend to have a synergistic effect to achieve greater brightness with less material, as shown by comparing the amount of optical brightener (4#/ton) used to achieve 84 brightness in the non-nPCC samples (Samples B and D) with the amount of optical brightener (2#/ton) used to achieve 84 brightness in the nPCC samples (Samples F and G) in EXAMPLE 10 and TABLE 6.

As shown below in the data in EXAMPLE 10 and TABLE 6, a substrate having 4#/ton OBA (e.g., 2#/ton added at the wet end and 2#/ton added at the size press) (Sample B) will change from 84 brightness to 82 brightness after about 2 months. The 2-point (2%) reduction in brightness is a result of the OBA breakdown. A substrate having a 1.0 gsm PEI surface treatment (without OBA optical brightener) (Sample C) will change from 78 brightness to 73 brightness after about 2 months. The 5-point (about 6%) reduction in brightness is a direct result of PEI yellowing. A substrate having a 1.0 gsm PEI off-line surface treatment together with 4#/ton OBA optical brightener (e.g., 2#/ton added at the wet end and 2#/ton added at the size press) (Sample D) will change from 84 brightness to 73 brightness after about 2 months. The 11-point (about 13%) reduction in brightness is a direct result of OBA breakdown and PEI yellowing.

In contrast, a substrate having an nPCC surface layer without a PEI treatment results in substantially reduced substrate yellowing over time, as compared to a substrate having PEI treatment. As shown below in the data in EXAMPLE 10 and TABLE 6, a substrate having 2.5 gsm nPCC surface layer (without OBA) (Sample E) will achieve 82 brightness and will not have any significant brightness reduction after about 2 months. While the substrate having an nPCC surface layer will likely not achieve the target brightness of 84 without OBA optical brightener, the brightness retention is maximized because there is no OBA breakdown. A substrate having 2#/ton OBA (e.g., 2#/ton added at the wet end) and a 2.5 gsm nPCC surface layer (Sample F) will change from 84 brightness to 83 brightness after about 2 months. The 1-point (about 1%) reduction in brightness is a result of the OBA breakdown.

Although a mixture of an nPCC surface layer and a PEI treatment will result in some brightness reduction over time as a result of PEI yellowing, the reduction is substantially improved over the PEI surface treatment without nPCC surface layer (see, e.g., Samples C and D). As shown below in the data in EXAMPLE 10 and TABLE 6, a substrate having 2#/ton OBA (e.g., 2#/ton added at the wet end) and a 2.5 gsm nPCC surface layer together with a 1.0 gsm PEI off-line surface treatment (Sample G) will change from 84 brightness to 81 brightness after about 2 months. The 3-point (about 4%) reduction in brightness is a result of the OBA breakdown and PEI yellowing.

A substrate having a surface layer in accordance with embodiments of the present disclosure has a less than about 10% brightness reduction after a period of about 2 months. In accordance with other embodiments of the present disclosure has a less than about 5% brightness reduction after a period of about 2 months. In accordance with other embodiments of the present disclosure has a less than about 2% brightness reduction after a period of about 2 months.

The nPCC surface layer may include other pigment components, including but not limited to clay, plastic pigments, silicates, alumina, and other known pigments, as well as mixtures thereof. Preferably the other pigment components are also nano-sized particles so as to maintain the binding efficiency of the nPCC surface layer.

While nPCC has self-binding capabilities, the surface layer may further include a binder to help improve the properties of the surface layer. Suitable binders include but are not limited to starch, latex, polyvinyl alcohol, carboxymethyl cellulose, glucomanllan, protein, and other known binders, as well as mixtures thereof. In one embodiment of the present disclosure, the surface layer of the cellulose based substrate includes about 0.1 to about 3 gsm binder. In another embodiment, the binder in the surface layer is present in an amount in the range of about 6% to about 12% of the basis weight of the cellulose based substrate. In one non-limiting example, starch binder in the surface layer improves the surface integrity of the cellulose based substrate. For comparative information, starch content on newsprint grade paper is generally about 0.15 gsm, and about 0.8 gsm on publication grade paper (i.e., book paper).

The nPCC surface layer may further include surface modifying chemicals, such as surface sizing, salts such as nitrate salt, charge modifiers, film formers, optical brighteners, latex, cross-linkers for starch-based formulations such as glyoxal, as well as other additives.

A preferred characteristics of the cellulose based substrate is toner adhesion as a result of nPCC present in the surface layer. Other characteristics of the cellulose based substrate may include basis weight, porosity, stiffness, caliper, brightness, opacity, as well as other optical properties, which may be a result of the substrate furnish and chemical additives to the slurry, surface layer materials, and machine conditions for the cellulose based substrate, for example, as described for high-yield paper in U.S. patent application Ser. No. 12/346,670 (WEYE Ref. 26547), the disclosure of which is hereby expressly incorporated by reference.

Stiffness is one important characteristic because of the limitations of current liquid toner printing presses, such as INDIGO® printers. In that regard, current substrates used in liquid toner printing presses are generally of a high basis weight, on the order of 60# or greater, and generally in the range of 60# to 120#. With improved substrate stiffness, as a result of nPCC content in the surface layer, a lower basis weight substrate is able to be processed in current liquid toner printing presses. In accordance with embodiments of the present disclosure, the basis weight of the substrate having a surface layer including nPCC may be less than about 60#, but still having a suitable stiffness for use in liquid toner printing presses. In accordance with embodiments of the present disclosure, the basis weight of the substrate having a surface layer including nPCC may be less than about 45#, but still having a suitable stiffness for use in liquid toner printing presses. Taber stiffness values are preferably equal to or greater than about 0.7 in the CD direction and equal to or greater than about 2.1 in the MD direction. Stiffness properties may be further enhance by nPCC morphology, as described in greater detail below.

As shown in the data collected in EXAMPLES 7 and 8 and TABLES 3 and 4 below, a cellulose based substrate having a surface layer including nPCC generally increases other desirable properties for increased amounts of nPCC content in the surface layer. For example, the data in EXAMPLE 7 and corresponding TABLE 3 shows improved stiffness and porosity characteristics with increased nPCC to starch ratios in the surface layer and in comparison with a GCC sample. The data in EXAMPLE 8 and corresponding TABLE 4 shows improved stiffness and porosity characteristics with increasing npCC content in the surface layer.

### nPCC Morphology

The morphology of the nPCC in the nPCC surface layer may also vary to further improve the properties of the cellulose based substrate, particularly stiffness characteristics as mentioned above. In that regard, nPCC is commonly available having a cubic-shaped morphology. However, nPCC having a needle-shaped morphology is also within the scope of the present disclosure. As described in greater detail below, a cellulose based substrate that includes long needle nPCC in the surface layer has many enhanced attributes compared to a sheet that has only cubic nPCC on its surface. The long needle nPCC may be about 15 to about 200 nm in diameter, and more preferably about 15 to about 50 nm in diameter, and about 4 to about 6 microns (about 4000 to about 6000 nanometers) in length. These dimensions compare to short needle nPCC having a length of about 1 to about 3 microns (about 1000 to about 3000 nanometers). FIGS. 3 and 4 are photomicrographs of the long needle nPCC. It can be seen that a majority of the needles are long needle nPCC; however, there are some short needles and debris associated with the long needle nPCC.

Long needle nPCC may be made using the high gravity reactive precipitation (HGRP) reactor and may be obtained, for example, from NanoMaterials Technology Pte Ltd (NMT). In addition, a long needle or long cigar nPCC having a length of about 4 to about 6 microns may be available from Solvay S. A. Solvay, which makes a needle-shaped aragonite nPCC Socal 90A, NZ and P2A and a cigar-shaped calcite nPCC Solvay P1V, P2, P2V, P3E, 93V, 94V, NP, N2, N2R. or P2PHV. The discussion of long needle nPCC throughout the specification includes long cigar shaped nPCC.

As a result of the morphology, use of long needle nPCC in the surface layer increases the stiffness of a cellulose based substrate, as compared to a cellulose based substrate that does not have long needle nPCC applied to its surface. Improved substrate stiffness allows a sheet to be used where substrate stiffness is required for post printing and conversion operations. Machine direction and cross direction Gurley stiffness and machine direction and cross direction Taber stiffness were used to determine the stiffness of the substrate. The machine direction and cross direction Gurley stiffness of a substrate is determined using TAPPI test method T-543. The machine direction and cross direction Taber stiffness of a substrate is determined using TAPPI test method T-489. In both methods the bending resistance of the substrate is determined by measuring the force required to bend a sample under controlled conditions.

The long needle nPCC may be combined with other materials normally added at the size press. In one embodiment, the surface layer materials include both the long needle nPCC and starch or ethylated starch. In one embodiment of the present disclosure, the amount of long needle nPCC may be in present in the surface layer of the substrate in an amount in the range of about 1.25% to about 15% of the basis weight of the cellulose based substrate. In another embodiment of the present disclosure, the amount of starch (such as ethylated starch) may be present in the surface layer in an amount in the range of about 6% to about 12% of the basis weight of the cellulose based substrate.

The long needle nPCC may also be combined with cubic or short needle nPCC. In one embodiment of present disclosure, long needle nPCC may be combined with an amount of cubic or short needle nPCC, such that total nPCC is in the range of from about 1.25% to about 15% of the basis weight of the cellulose based substrate. In addition, the long needle, short needle, and/or cubic nPCC may be combined with other pigment additives.

As shown in the data collected in EXAMPLES 1-6 and TABLES 1 and 2 below, paper having a surface layer including long needle nPCC generally has a greater machine direction and cross direction Gurley stiffness and machine direction and cross direction Taber stiffness than paper having a surface layer including standard size press additives only, such as starch or ethylated starch, or with cubic or short needle nPCC alone. However, paper having a surface layer including long needle nPCC and cubic nPCC also shows greater machine direction and cross direction Gurley stiffness and machine direction and cross direction Taber stiffness than paper having a surface layer including standard size press additives only, such as ethylated starch, or with cubic or short needle nPCC alone.

In some embodiments of the present disclosure, the inventors have found that a substrate having a surface layer including long needle nPCC may have an increase in both machine direction and cross direction Gurley stiffness of 15 to 20% when compared with a substrate having a surface layer including standard size press additives, such as starch and cubic or short needle nPCC. A substrate having a surface layer including long needle nPCC may have an increase in both machine direction and cross direction Gurley stiffness of 5 to 10% when compared to a substrate having a surface layer including cubic nPCC. A substrate having a surface layer including long needle nPCC may have an increase in machine direction Gurley stiffness of 7 to 12% and an increase in cross direction Gurley stiffness of 20 to 25% when compared to a substrate having a surface layer including short needle nPCC.

A substrate having a surface layer including long needle nPCC may have an increase in both machine direction and cross direction Taber stiffness of 13 to 20% when compared with a substrate having a surface layer including standard size press additives. A substrate having a surface layer including long needle npCC may have an increase in both machine direction and cross direction Taber stiffness of 5 to 12% when compared to a substrate having a surface layer including cubic nPCC. A substrate having a surface layer including long needle nPCC may have an increase in machine direction Taber stiffness of 12 to 17% and in cross direction Gurley stiffness of 25 to 30% when compared to a substrate having a surface layer including short needle nPCC.

A substrate having a surface layer including a combination of the long needle nPCC and cubic or short needle nPCC may also have a greater machine direction and cross direction Gurley stiffness and machine direction and cross direction Taber stiffness than a substrate having a surface layer including standard size press additives only, or with cubic or short needle nPCC, on in some cases long needle nPCC only.

A substrate having a surface layer including a combination of long needle nPCC and cubic or short needle nPCC may have an increase in both machine direction and cross direction Gurley stiffness of 20 to 25% when compared with a substrate having a surface layer including standard size press additives. A substrate having a surface layer including a combination of long needle nPCC and cubic or short needle npCC may have an increase in both machine direction and cross direction Gurley stiffness of 10 to 15% when compared to a substrate having a surface layer including cubic nPCC. A substrate having a surface layer including a combination of long needle nPCC and cubic or short needle nPCC may have an increase in machine direction Gurley stiffness of 10 to 15% and in cross direction Gurley stiffness of 25 to 30% when compared to a substrate having a surface layer including short needle nPCC.

A substrate having a surface layer including a combination of long needle nPCC and cubic or short needle nPCC may have an increase in machine direction Taber stiffness of 15 to 20% and in cross direction Taber stiffness of 20 to 25% when compared with a substrate having a surface layer including standard size press additives. A substrate having a surface layer including a combination of long needle nPCC and cubic or short needle nPCC may have an increase in both machine direction Taber stiffness of 7 to 12% and in cross direction Taber stiffness of 14 to 20% when compared to a substrate having a surface layer including cubic nPCC. A substrate having a surface layer including a combination of long needle nPCC and cubic or short needle nPCC may have an increase in machine direction Taber stiffness of 15 to 20% and an increase in cross direction Gurley stiffness of 30 to 40% when compared to a substrate having a surface layer including short needle nPCC.

### EXAMPLES

EXAMPLES 1-5 and associated TABLE 1 include data relating to pigment morphology and provide stiffness values for five different surface layer formulations: ethylated starch (EXAMPLE 1), cubic nPCC (EXAMPLE 2), short needle nPCC (EXAMPLE 3), long needle nPCC (EXAMPLE 4), and a mixture of the long needle and cubic nPCC (EXAMPLE 5). From the results of EXAMPLES 1-5, it can be seen that the surface layers including long needle nPCC (EXAMPLE4) and a mixture of the long needle and cubic nPCC (EXAMPLE 5) provide greater stiffness in both machine direction and cross direction than standard materials (e.g., ethylated starch), cubic nPCC, and short needle nPCC, as discussed in greater detail below.

EXAMPLE 6 and associated TABLE 2 include data relating to pigment morphology and provide stiffness and brightness values for four different surface layer formulations: Sample A has a surface layer including control starch; Sample B has a surface layer include cubic nPCC; Sample C has a surface layer include short needle nPCC; and Sample D has a surface layer include long needle nPCC. The data shows that Gurley and Taber stiffness values in both the MD and the CD increase significantly for samples having a surface layer including 4 micron long needle nPCC. In addition, brightness values increased for samples having a surface layer including cubic, 2 micron short needle nPCC, and 4 micron long needle nPCC.

EXAMPLE 7 and associated TABLE 3 include data relating to increasing ratios of cubic. nPCC compared to starch in paper samples having the following nPCC and starch surface layers: Sample A includes a surface layer having control starch; Sample B includes a surface layer having nPCC and starch in a ratio of 0.43 to 1; Sample C includes a surface layer having nPCC and starch in a ratio of 0.80 to 1; Sample D includes a surface layer having npCC and starch in a ratio of 1.20 to 1; and Sample E includes a surface layer having GCC and starch in a ratio of 1.20 to 1. The data shows improved stiffness and porosity characteristics than control starch and CCC with increased nPCC to starch ratios in the surface layer.

EXAMPLE 8 and associated TABLE 4 include data relating to increasing amounts of cubic nPCC while maintaining similar starch content in paper samples having the following nPCC and starch surface layers: Sample I includes a control starch surface layer; Sample 2 includes a GCC surface layer; Sample 3-6 include nPCC surface layers, with similar starch contents and increasing amounts of nPCC in the surface layer. Samples 1 and 2 relating to starch control and GCC surface layers were included for comparison. The data shows improved stiffness and lower porosity characteristics with increasing nPCC content in the surface layer.

EXAMPLE 9 and associated TABLE 5 include data relating to tape pull testing on 45# newsprint grade paper samples (Samples 1-6) having varying amounts of nPCC in the surface layer from 0 to 3.0 gsm nPCC and comparing to PEI treated paper. The data in TABLE 5 below shows that the average tape pull values improve with increased amounts of nPCC in the surface layer on 45# newsprint grade paper samples.

EXAMPLE 10 and associated TABLE 6 include data relating to achieving a brightness of 84 from an initial brightness of 78 using brightening agents for comparison with a control sample (Sample A). The data in TABLE 6 shows that substrates having an nPCC surface layer have improved brightness retention over substrates having added OBA optical brightener alone or PEI treatment alone. Substrates having a mixed nPCC surface layer, with added OBA and PEI treatment have improved brightness retention over substrates having PEI treatment alone.

### Example 1

### Starch Surface Layer

Seven 8½×11 sheets of 45 pound per ream newsprint were coated with ethylated starch (Penford Gum 280). The following is an average for the seven samples. The average total solids were 8% of the weight of the paper substrates. The average coated weight of the samples was 6.41 grams. The average coat weight was 2.3 grams or 58.2 pounds per ton. The ambient viscosity was 62/2. The samples were dried. The average dry weight of the samples was 4.7 grams. The samples were tested for machine direction (MD) and cross direction (CD) Gurley stiffness and machine direction and cross direction Taber stiffness. The average MD Gurley stiffness was 172.08, the average CD Gurley stiffness was 56.43, the average MD Taber stiffness was 2.18 and the average CD Taber stiffness was 0.76.

### Example 2

### Cubic nPCC Surface Layer

Seven 8½×11 sheets of 45 pound per ream newsprint were coated with ethylated starch (Penford Gum 280) and cubic nano precipitated calcium carbonate (nPCC-II). The following is an average for the seven samples. The average total solids were 16% of the weight of the paper substrates, 8% Penford Gum 280 and 8% cubic nPCC. The average coated weight of the samples was 6.46 grams. The average coat weight was 4.7 grams or 120.8 pounds per ton. The ambient viscosity was 355/2. The samples were dried. The average dry weight of the samples was 4.69 grams. The samples were tested for machine direction (MD) and cross direction (CD) Gurley stiffness and machine direction and cross direction Taber stiffness. The average MD Gurley stiffness was 189.04, the average CD Gurley stiffness was 61.3, the average MD Taber stiffness was 2.33 and the average CD Taber stiffness was 0.81.

### Example 3

### Short Needle nPCC Surface Layer

Seven 8½×11 sheets of 45 pound per ream newsprint were coated with ethylated starch (Penford Gum 280) and short needle nPCC (length 1-3 microns). The following is an average for the seven samples. The average total solids were 16% of the weight of the paper substrates, 8% Penford Gum 280 and 8% small needle nPCC. The average coated weight of the samples was 6.35 grams. The average coat weight was 4.5 grams or 117.9 pounds per ton. The ambient viscosity was 344/2. The samples were dried. The average dry weight of the samples was 4.64 grams. The samples were tested for machine direction (MD) and cross direction (CD) Gurley stiffness and machine direction and cross direction Taber stiffness. The average MD Gurley stiffness was 185.7, the average CD Gurley stiffness was 53.89, the average MD Taber stiffness was 2.17 and the average CD Taber stiffness was 0.70.

### Example 4

### Long Needle nPCC Surface Layer

Seven 8½×11 sheets of 45 pound per ream newsprint were coated with ethylated starch (Penford Gum 280) and long needle nPCC. The following is an average for the seven samples. The average total solids were 16% of the weight of the paper substrates, 8% Penford Gum 280 and 8% long needle nPCC. The average coated weight of the samples was 6.54 grams. The average coat weight was 4.9 grams or 127.2 pounds per ton. The ambient viscosity was 356/2. The samples were dried. The average dry weight of the samples was 4.68 grams. The samples were tested for machine direction (MD) and cross direction (CD) Gurley stiffness and machine direction and cross direction Taber stiffness. The average MD Gurley stiffness was 202.94, the average CD Gurley stiffness was 66.46, the average MD Taber stiffness was 2.48 and the average CD Taber stiffness was 0.89.

The MD Gurley stiffness of the long needle nPCC sample (EXAMPLE 4) was 18% greater than the ethylated starch sample (EXAMPLE 1), 7% greater than the cubic nPCC sample (EXAMPLE 2), and 9% greater than the short needle nPCC sample (EXAMPLE 3).

The CD Gurley stiffness of the long needle nPCC sample (EXAMPLE 4) was 18% greater than the ethylated starch sample (EXAMPLE 1), 8% greater than the cubic nPCC sample (EXAMPLE 2), and 23% greater than the short needle nPCC sample (EXAMPLE 3).

The MD Taber stiffness of the long needle nPCC sample (EXAMPLE 4) was 14% greater than the ethylated starch sample (EXAMPLE 1), 6% greater than the cubic nPCC sample (EXAMPLE 2), and 14% greater than the short needle nPCC sample (EXAMPLE 3).

The CD Taber stiffness of the long needle nPCC sample (EXAMPLE 4) was 17% greater than the ethylated starch sample (EXAMPLE 1), 10% greater than the cubic nPCC sample (EXAMPLE 2), and 27% greater than the short needle npCC sample (EXAMPLE 3).

### Example 5

### Long Needle and Cubic nPCC Surface Layer

Seven 8½×11 sheets of 45 pound per ream newsprint were coated with ethylated starch (Penford Gum 280), long needle nPCC and cubic nPCC. The following is an average for the seven samples. The average total solids were 16% of the weight of the paper substrates, 8% Penford Gum 280, 4% long needle nPCC and 4% cubic nPCC. The average coated weight of the samples was 6.49 grams. The average coat weight was 4.6 grams or 116.3 pounds per ton. The ambient viscosity was 290/2. The samples were dried. The average dry weight of the samples was 4.76 grams. The samples were tested for machine direction (MD) and cross direction (CD) Gurley stiffness and machine direction and cross direction Taber stiffness. The average MD Gurley stiffness was 209.61, the average CD Gurley stiffness was 68.82, the average MD Taber stiffness was 2.56 and the average CD Taber stiffness was 0.94.

The MD Gurley stiffness of the long needle and cubic nPCC sample (EXAMPLE 5) was 22% greater than the ethylated starch sample (EXAMPLE 1), 11% greater than the cubic nPCC sample (EXAMPLE 2), and 13% greater than the short needle nPCC sample (EXAMPLE 3).

The CD Gurley stiffness of the long needle and cubic nPCC sample (EXAMPLE5) was 22% greater than the ethylated starch sample (EXAMPLE 1), 12% greater than the cubic nPCC sample (EXAMPLE 2), and 28% greater than the short needle nPCC sample (EXAMPLE 3).

The MD Taber stiffness of the long needle and cubic nPCC sample (EXAMPLE 5) was 17% greater than the ethylated starch sample (EXAMPLE 1), 10% greater than the cubic nPCC sample (EXAMPLE 2), and 28% greater than the short needle nPCC sample (EXAMPLE 3).

The CD Taber stiffness of the long needle and cubic nPCC sample (EXAMPLE 5) was 24% greater than the ethylated starch sample (EXAMPLE 1), 16% greater than the cubic nPCC sample (EXAMPLE 2), and 34% greater than the short needle nPCC sample (EXAMPLE 3).

TABLE 1 below summarizes the data from EXAMPLES 1-5.

TABLE 1

| | Sample | | | | |
|---|---|---|---|---|---|
| | Example 1 | | Example 3 | Example 4 | Example 5 |
| | Ethylated | Example 2 | Short Needle | Long Needle | Long and |
| | Starch | Cubic nPCC | nPCC | nPCC | Cubic nPCC |
| Total solids | 8% EStarch | 16% Total | 16% Total | 16% Total | 16% Total |
| | | 8% EStarch | 8% EStarch | 8% EStarch | 8% EStarch |
| | | 8% CnPCC | 8% SNnPCC | 8% LNnPCC | 4% CnPCC |
| | | | | | 4% LNnPCC |
| Coated wt. of | 6.41 | 6.46 | 6.35 | 6.54 | 6.49 |
| sample (g) | | | | | |
| Coat Wt. (g) | 2.3 | 4.7 | 4.5 | 4.9 | 4.6 |
| Coating ambient | 62/2 | 355/2 | 344/2 | 356/2 | 290/2 |
| viscosity | | | | | |
| Dry wt. of sample | 4.7 | 4.69 | 4.64 | 4.68 | 4.76 |
| (g) | | | | | |
| Gurley Stiffness | 172.08 | 189.04 | 185.7 | 202.94 | 209.61 |
| MD | | | | | |
| Gurley Stiffness | 56.43 | 61.3 | 53.89 | 66.46 | 68.82 |
| CD | | | | | |
| Taber Stiffness MD | 2.18 | 2.33 | 2.17 | 2.48 | 2.56 |
| Taber Stiffness CD | 0.76 | 0.81 | 0.70 | 0.89 | 0.94 |

### Example 6

### Comparative Morphology

Four different paper samples were tested for stiffness and brightness. Sample A has a surface layer including control starch, without pigmentation. Sample B has a surface layer including cubic nPCC. Sample C has a surface layer including about 2 micron short needle nPCC. Sample D has a surface layer including about 4 micron long needle nPCC. The data in TABLE 2 below shows that Gurley and Taber stiffness values in both the MD and the CD increase significantly for samples having a surface layer including 4 micron long needle nPCC. In addition, brightness values increased for samples having a surface layer including cubic, 2 micron short needle nPCC, and 4 micron long needle nPCC.

TABLE 2

| | Sample | | | |
|---|---|---|---|---|
| | A | B | C | D |
| | Control | Cubic | 2 micron Short | 4 micron Long |
| | Starch | nPCC | Needle nPCC | Needle nPCC |
| Gurley | 82.14 | 85.8 | 83.3 | 96.35 |
| Stiffness MD | | | | |
| Gurley | 31.58 | 31.58 | 31.9 | 38.15 |
| Stiffness CD | | | | |
| Brightness | 76.14 | 76.7 | 76.9 | 77.18 |
| Taber Stiffness | 1.160 | 1.150 | 1.060 | 1.210 |
| MD | | | | |
| Taber Stiffness | 0.388 | 0.440 | 0.466 | 0.440 |
| CD | | | | |

### Example 7

### Lab Data

Paper characteristics were determined for four comparative samples having four different surface layers: Sample A includes a surface layer having control starch; Sample B includes a surface layer having nPCC and starch in a ratio of 0.43 to 1; Sample C includes a surface layer having nPCC and starch in a ratio of 0.80 to 1; and Sample D includes a surface layer having nPCC and starch in a ratio of 1.20 to 1; and Sample E includes a surface layer having GCC and starch in a ratio of 1.20 to 1. All nPCC samples used cubic nPCC.

The data in TABLE 3 below shows improved stiffness and porosity characteristics with increased nPCC to starch ratios in the surface layer. Moreover, comparing the results for the GCC sample (Sample E) with the nPCC samples (Samples B, C, and D), GCC does not achieve the stiffness and porosity characteristics achieved by the lowest ratio nPCC sample (SAMPLE B), and even does not perform as well as starch alone. (Sample A).

TABLE 3

| | Sample | | | | |
|---|---|---|---|---|---|
| | | B | C | D | E |
| | A | nPCC to | nPCC to | nPCC to | GCC to |
| | Control | Starch | Starch | Starch | Starch |
| | Starch | 0.43:1 | 0.80:1 | 1.20:1 | 1.20:1 |
| Gurley Stiffness | 39.68 | 41.12 | 49.84 | 45.12 | 39.7 |
| MD | | | | | |
| Gurley Stiffness | 10.68 | 11.68 | 11.67 | 12.98 | 11.14 |
| CD | | | | | |
| Taber Stiffness | 0.506 | 0.502 | 0.564 | 0.701 | 0.501 |
| MD | | | | | |
| Taber Stiffness | 0.212 | 0.200 | 0.211 | 0.232 | 0.211 |
| CD | | | | | |
| Hagerty | 70.5 | 71.7 | 67.6 | 68.8 | 70.9 |
| Roughness | | | | | |
| Gurley Porosity | 88.2 | 110.5 | 122.9 | 137.4 | 99.7 |
| (sec/100 mL) | | | | | |
| Opacity % | 92.833 | 93.283 | 92.887 | 94.741 | 92.9 |

### Example 8

### Commercial Data

Paper characteristics are shown for five comparative samples having five different surface layers: Sample I includes a control starch surface layer for comparison; Samples 2-5 include nPCC surface layers, with similar starch contents and increasing amounts of nPCC in the surface layer. Sample 1 relating to starch control was included for comparison. All nPCC samples used cubic nPCC.

The data in TABLE 4 below shows improved stiffness and porosity characteristics with increasing nPCC content in the surface layer.

TABLE 4

| | Sample | | | | |
|---|---|---|---|---|---|
| | 1 | 2 | 3 | 4 | 5 |
| | Starch | nPCC | nPCC | nPCC | nPCC |
| Basis Weight# | 45 | 45 | 45 | 45 | 45 |
| Starch (gsm) | 0.991 | 1.285 | 0.872 | 0.973 | 0.877 |
| nPCC (gsm) | 0 | 1.324 | 2.437 | 3.280 | 5.373 |
| total surface layer (gsm) | 1.307 | 2.609 | 3.309 | 4.253 | 6.250 |
| base ash % | 14.90 | 12.00 | 13.63 | 8.08 | 9.50 |
| surface layer ash % | 0.43 | 1.81 | 3.33 | 4.48 | 7.34 |
| total ash % | 15.33 | 16.81 | 18.33 | 19.48 | 22.34 |
| Taber Stiffness MD | 2.203 | 2.663 | 2.368 | 2.654 | 2.451 |
| Taber Stiffness CD | 0.688 | 0.769 | 0.755 | 0.752 | 0.743 |
| Gurley porosity | 29 | 35 | 62 | 40 | 57 |
| Sheffield porosity | 108 | 92 | 58 | 80 | 61 |

### Example 9

### Tape Pull Evaluation

Tape pull evaluation tests were performed on five 45# newsprint grade paper samples (Samples 2-6) having varying amounts of nPCC in the surface layer from 0.5 to 3.0 gsm nPCC. Sample I is a control sample of 45# newsprint grade paper sample having no nPCC in the surface layer. The data in TABLE 5 below shows that the average tape pull values improve with increased amounts of nPCC in the surface layer on 45# newsprint grade paper samples. Sample 7 includes a PEI treated surface layer on an 80# glossy grade paper sample that was highly calendared for a glossy finish and increased smoothness. The Sample 7 data has also been normalized to provide approximated tape pull results for a 45# newsprint grade paper.

Photographic images of the tape pull results are shown in FIGS. 1-7: 0 gsm nPCC (FIG. 1); 0.5 gsm nPCC (FIG. 2); 1.5 gsm nPCC (FIG. 3); 2.0 gsm nPCC (FIG. 4); 2.5 gsm nPCC (FIG. 5); 3.0 gsm nPCC (FIG. 6); and PEI treatment (FIG. 7).

TABLE 5

| | Sample | | | | | | |
|---|---|---|---|---|---|---|---|
| | | 2 | 3 | 4 | 5 | 6 | 7 |
| | 1 | nPCC | nPCC | nPCC | nPCC | nPCC | PEI |
| nPCC, gsm | 0 | 0.5 | 1.5 | 2.0 | 2.5 | 3.0 | 0.0 |
| PEI, gsm | — | — | — | — | — | — | 1.0 |
| Tape pull, % | 7.67 | 1.970 | 1.390 | 0.865 | 0.860 | 0.378 | 0.5 |
| 45# Newsprint | | | | | | | |
| Tape pull, % | — | — | — | — | — | — | 0.006 |
| 80# Glossy | | | | | | | |

### Example 10

Four different samples are prepared to achieve a paper brightness of 84 from an initial brightness of 78 using brightening agents for comparison with a control sample (Sample A). Results are shown below in TABLE 6. Brightness values are generally measured according to TAPPI Brightness Method T452 om-02.

Sample B achieves 84 brightness using 4#/ton of OBA optical brightener (e.g., 2#/ton added at the wet end and 2#/ton added at the size press). After about 2 months time, the brightness of Sample B decreases to 82. Sample C achieves only 78 brightness using 1.0 gsm of PEI as an surface treatment (without OBA) because PEI does not add any brightness value. After about 2 months time, the brightness of Sample C decreases to 73. Sample D achieves 84 brightness using 2#/ton of OBA (e.g., 2#/ton added at the wet end) and 1.0 gsm of PEI (off-line surface treatment). After about 2 months time, the brightness of Sample D decreases to 73. Sample E achieves 82 brightness using 2.5 gsm nPCC (added at the size press). After about 2 months time, the brightness of Sample E remains at 82. Sample F achieves 84 brightness using 2#/ton of OBA (e.g., 2#/ton added at the wet end) and 2.5 gsm nPCC (added at the size press). After about 2 months time, the brightness of Sample F decreases to 83. Sample G achieves 84 brightness using 2#/ton of OBA (e.g., 2#/ton added at the wet end), 2.5 gsm nPCC (added at the size press), and 0.5 gsm PEI (off-line surface treatment). After about 2 months time, the brightness of Sample G decreases to 81.

The data in TABLE 6 shows that substrates having an nPCC surface layer will have improved brightness retention over substrates having added OBA optical brightener alone or PEI treatment alone. Substrates having a mixed nPCC surface layer, with added OBA and PEI treatment have improved brightness retention over substrates having PEI treatment alone.

TABLE 6

| | Sample | | | | | | |
|---|---|---|---|---|---|---|---|
| | | | | | | | G |
| | | | | D | | F | OBA, |
| | A | B | C | OBA, | E | OBA, | PEI |
| | Control | OBA | PEI | PEI | nPCC | nPCC | nPCC |
| OBA, #/ton | — | 4 | — | 4 | — | 2 | 2 |
| PEI, gsm | — | — | 1.0 | 1.0 | — | — | 0.5 |
| nPCC, gsm | — | — | — | — | 2.5 | 2.5 | 2.5 |
| Initial | 78 | 84 | 78 | 84 | 82 | 84 | 84 |
| Brightness | | | | | | | |
| Brightness | 78 | 82 | 73 | 73 | 82 | 83 | 81 |
| after about | | | | | | | |
| 2 months | | | | | | | |

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. While illustrative embodiments have been illustrated and described, it will be appreciated that various changes can be made therein without departing from the spirit and scope of the disclosure.

The embodiments of the invention in which an exclusive property or privilege is claimed as defined as follows:

1. A method of printing using liquid toner, comprising:
(a) obtaining a cellulose based substrate having a surface layer including nPCC; and
(b) printing on the cellulose based substrate using a liquid toner printer to achieve tape pull results of less than about 7%.

2. The method of claim 1, wherein the method achieves tape pull results selected from the group consisting of less than about 5%, less than about 2%, less than about 1.5%, less than about I%, and less than about 0.5%.

3. The method of claim 1, wherein the surface layer on the sheet includes an amount of nPCC selected from the group consisting of about 0.5 to about 10 gsm nPCC, about I to about 6 gsm nPCC, and about 2 to about 5 gsm nPCC.

4. The method of claim 1, wherein the surface layer includes a binder.

5. The method of claim 4, wherein the binder is selected from the group consisting of a binder component selected from the group consisting starch, latex, polyvinyl alcohol, carboxymethyl cellulose, glucomannan, protein, and other known binders, and any combination thereof.

6. The method of claim 4, wherein the surface layer on the sheet further includes about 0.1 to about 3 gsm binder.

7. The method of claim 1, wherein the basis weight of the cellulose based substrate in a range selected from the group consisting of less than about 60 pounds and less than about 45 pounds.

8. The method of claim 1, wherein the brightness reduction of the cellulose based substrate after a two month period of time is selected from the group consisting of less than 10%, less than 5%, and less than 2%.

9. The method of claim 1, wherein the particle size of the nPCC is selected from the group consisting of less than about 200 nanometers, less than about 100 nanometers, and about 15 to about 40 nanometers.

10. The method of claim 1, wherein the nPCC comprises substantially non-agglomerated particles.

11. The method of claim 1, wherein the nPCC has a substantially needle-shaped morphology.

12. The method of claim 11, wherein the needle-shaped nPCC has a diameter in the range of about 15 to about 200 nanometers.

13. The method of claim 11, wherein the needle-shaped nPCC has a length in a range selected from the group consisting of greater than 1 micron and about 4 to about 6 microns.

14. The method of claim 1, wherein the surface layer on the sheet further includes a nano-sized pigment selected from the group consisting of clay, plastic pigments, silicates, alumina, and mixtures thereof.

15. The method of claim 1, wherein the surface layer further includes PEI.

16. A method of printing on a cellulose based substrate using liquid toner, comprising:
(a) obtaining a cellulose based substrate having a surface layer, wherein the surface layer does not include PEI; and
(b) printing on the cellulose based substrate using a liquid toner printer to achieve tape pull results of less than about 7%.

17. The method of claim 16, wherein the surface layer on the sheet includes an amount of nPCC selected from the group consisting of about 0.5 to about 10 gsm nPCC, about I to about 6 gsm nPCC, and about 2 to about 5 gsm nPCC.

18. The method of claim 16, wherein the basis weight of the cellulose based substrate is less than about 60 pounds.

19. The method of claim 16, wherein the Taber stiffness of the cellulose based substrate is equal to or greater than about 0.7 in the CD direction and equal to or greater than about 2.1 in the MD direction.

20. A method of printing on a cellulose based substrate using liquid toner, comprising:
(a) obtaining a cellulose based substrate having a surface layer; and
(b) printing on the cellulose based substrate using a liquid toner printer to achieve tape pull results of less than about 7%, wherein the cellulose based substrate has less than 10% brightness reduction after a period of about 2 months.
